(19) United States
(12) Patent Application Publication
(10) Pub. No.: US 2018/0312650 A1
(43) Pub. Date: Nov. 1, 2018

(54) THERMALLY CONDUCTIVE COMPOSITION VIA COATING ON PLASTICS

(71) Applicant: SABIC Global Technologies B.V., Bergen op Zoom (NL)

(72) Inventors: Yaqin ZHANG, Shanghai (CN); Ming GU, Shanghai (CN); Feng JIANG, Shanghai (CN); Mingcheng GUO, Shanghai (CN)

(21) Appl. No.: 15/770,986

(22) PCT Filed: Oct. 17, 2016
(86) PCT No.: PCT/IB2016/056226

§ 371 Date: Apr. 25, 2018

Related U.S. Application Data
(60) Provisional application No. 62/248,455, filed on Oct. 30, 2015.

(51) Int. Cl. C08J 7/04; C09D 5/24; C09D 5/32

(52) U.S. Cl. CPC C08J 7/04; C09D 5/24; B32B 27/40; C08J 2375/04; C08J 2369/00; C09D 5/32

(57) ABSTRACT

An article may comprise a substrate formed from a thermoplastic or thermoset; and a thermal conductive or heat absorptive coating disposed adjacent the substrate to form a composite stack, wherein the composite stack is characterized by an increase of through plane thermal conductivity of at least 2 W/m*K, when compared to the substrate without the coating.

### RELATED APPLICATIONS

This application claims benefit of U.S. Patent Application No. 62/248,455, filed Oct. 30, 2015, the disclosure of which is incorporated herein in its entirety.

### BACKGROUND

For consumer electronics devices, heat accumulation during use may decrease the device efficiency and may shorten life span. From a user's perspective the accumulated heat may be uncomfortable to the touch. Thus, thermal management such as heat dissipation is critical for such devices and use of the same. As an example, adding thermal conductive fillers into thermoplastic or thermoset is an effective method to improve thermal conductivity and such thermally conductive compositions can be used on the consumer electronic device for heat dissipation. However, consumer electronics are developing and include mobile devices with increasing electronics capabilities, power, and larger display screens, which results in more heat generated during use. To further the issue, consumer electronics are being manufactured with thinner designs, thereby limiting the space for heat dissipation and requiring higher thermal conductivity. Such levels of thermal conductivity may not be achieved by adding additional thermal conductive fillers as there is a limitation in thermal conductivity using filler. Additionally, the increased loading of thermal conductive filler may result in undesirable effects relating to mechanical performance and flame retardant (FR) performance, for example.

These and other shortcomings of the prior art are addressed by the present disclosure.

### SUMMARY

The present disclosure relates to blended thermoplastic polymer compositions having super high thermal conductivity, which can be obtained by using thermal conductive or heat absorptive coating on thermoplastic. Thermoplastic has low or medium thermal conductivity level (e.g., less than 2 W/m*K), while the thermal conductivity can be largely improved with coating.

In an aspect, an article may comprise a substrate formed from a thermoplastic or thermoset; and a thermal conductive or heat absorptive coating disposed adjacent the substrate to form a composite stack, wherein the composite stack is characterized by an increase of through plane thermal conductivity of at least 2 W/m*K, when compared to the substrate without the coating.

In various further aspects, the disclosure relates to articles comprising the disclosed compositions.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

In an aspect, high thermal conductivity (e.g., greater than 2 W/m*K, greater than 6 W/m*K, between 2 W/m*K and 30 W/m*K) may be obtained in a thermoplastic article by using thermal conductive or heat absorptive coating on the thermoplastic. It will be understood that thermoplastic may have a low thermal conductivity level, while the thermal conductivity can be improved through a thermoplastic layer by providing a coating. Table 1 illustrates a list of raw materials that may be used. However, other resins, fillers, stabilizers, and coatings may be used to effect the desired thermal conductivity, as described herein.

(1) THE TABLE 1. RAW MATERIAL LIST

| SABIC IP | | | |
|---|---|---|---|
| Raw material | | | |
| code | Description | Cas# | Function |
| 83900 | PA6 Regular | 25038-54-4 | Resin |
| | Ultramid B27 | | |
| F544397 | Graphite 1125 from | 7782-42-5 | Filler |
| | Asbury | | |
| F54GR50 | Graphite GFG50 | 7782-42-5 | Filler |
| | from SGL | | |
| F494471 | Magnesium | 1309-42-8 | Filler |
| | hydroxide Mg(OH)2 | | |
| | H5IV | | |
| F325125 | TEGOMER | | Impact modifier |
| | ANTISCRATCH 200 | | |
| | from Evonik | | |
| 25808 | HINDERED | 23128-74-7 | Thermal stabilizer |
| | PHENOL ANTI- | | |
| | OXIDANT | | |
| F542 | PHOSPHITE | 31570-04-4 | Thermal stabilizer |
| | STABILIZER | | |
| | AEROGLAZE Z306 | | Thermal |
| | | | Absorptive Coating |
| | Ultra conductive | | Thermal Diffusive |
| | coating E1007580 | | Coating |
| | PT A | | |
| | Ultra conductive | | Thermal |
| | coating E1007680 | | Diffusive Coating |
| | PT B | | |

In an aspect, a substrate may be comprised or formed from a polypropylene, polyethylene, ethylene based copolymer, polycarbonate, polyamide, polyester, polybutylene terephthalate (PBT), polyethylene terephthalate (PET), polycyclohexylendimethylene terephthalate (PCT), liquid crystal polymers (LPC), polyphenylene Sulfide (PPS), polyphenylene ether (PPE), polyphenylene oxide-polystyrene blends, polystyrene, high impact modified polystyrene, acrylonitrile-butadiene-styrene (ABS) terpolymer, acrylic polymer, polyetherimide (PEI), polyurethane, polyetheretherketone (PEEK), poly ether sulphone (PES), and mixtures of any of the foregoing.

The polymer substrate may be a pure resin or may comprise one or more of a filler, impact modifier, FR component, reinforce agent, stabilizer, or additive, or a combination thereof. The FR component may include phosphorus-containing flame retardants such as bisphenol-A diphenyl phosphate (BPADP), RDP (resorcinol diphosphate), sol-DP, Phenoxyphosphazene oligomer, BDP (Bisphenol-A Bis(Diphenyl Phosphate)). Clariant OP series, inorganic FR fillers such as Al(OH)3 (Gibbsite), Mg(OH)2 magnesium hydroxide, Bromine containing FR components, or a combination thereof. The thermoplastic compositions as described herein are suitable for use in a wide variety of compositions and applications as is known in the art. The thermoplastic composition can comprise one or more additives selected to achieve a desired property, with the proviso that the additive(s) are also selected so as to not significantly adversely affect a desired property of the thermoplastic composition. The additive composition or individual additives can be mixed at a suitable time during the mixing of the components for forming the composition. The additive can be soluble and/or non-soluble in polymer. The reinforcing agent may include glass fiber, carbon fiber, walastonite whisker, CaSO4 whisker, or a combination thereof. Other FR components and reinforcing agents may be used.

The additive composition can include an impact modifier, flow modifier, filler (e.g., a particulate polytetrafluoroethylene (PTFE), glass, carbon, mineral, or metal), reinforcing agent (e.g., glass fibers), impact modifier, antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g, a dye or pigment), surface effect additive, radiation stabilizer, flame retardant, anti-drip agent (e.g., a PTFE-encapsulated styrene-acrylonitrile copolymer (TSAN)), AlN, Al4C3, Al2O3, BN, AlON, MgSiN2, SiC, Si3N4, graphite, expanded graphite, graphene, carbon fiber, ZnS, CaO, MgO, ZnO, TiO2, Mg(OH)2 (Magnesium hydroxide), H2Mg3(SiO3)4 (Talc), γ-AlO(OH) (Boehmite), α-AlO(OH) (Diaspore), Al(OH)3 (Gibbsite), CaCO3, mica, BaO, BaSO4, CaSiO3, ZrO2, SiO2, glass beads, MgO.xAl2O3, CaMg(CO3)2, ceramic-coated graphite, clay; or a combination comprising at least one of the foregoing fillers, or a combination comprising one or more of the foregoing. For example, a combination of a heat stabilizer, mold release agent, and ultraviolet light stabilizer can be used. In general, the additives are used in the amounts generally known to be effective. The fillers may be surface treated or not.

Any foregoing mentioned polymer matrix, thermal conductive fillers, white pigment, optical brightened agents and or any other additives may first be dry blended together, then feed into an extruder from one or multi-feeders, or separately feed into extruder from one or multi-feeders. Any foregoing mentioned powder or pellet shaped organic polymer or any polymers combinations may be first dry blended with each other, or dry blended with any combination of foregoing mentioned fillers or additives, then feed into an extruder from one or multi-feeders, or separately feed into extruder from one or multi-feeders. The fillers described herein may also be first processed into a master batch, then feed into an extruder. As an example, compounding of the materials of Table 1 was processed on a Toshiba SE37 mm twin-screw extruder.

The feeding of organic polymers, additives, fillers and reinforcing agents, master batch or any combination of polymers, fillers blends may be fed into an extruder from throat hopper or any side feeders.

Various extruders may be used. The extruders may have a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations comprising at least one of the foregoing. Melt blending of the composites may involve the use of shear force, extensional force, compressive force, ultrasonic energy, electromagnetic energy, thermal energy or combinations comprising at least one of the foregoing forces or forms of energy.

The barrel temperature on the extruder during compounding may be set at the temperature where at least a portion of the organic polymer has reached a temperature greater than or equal to about the melting temperature, if the resin is a semi-crystalline organic polymer. Alternatively, the temperature may be set to a flow point temperature (e.g., the glass transition temperature) if the resin is an amorphous resin. In embodiments, samples were prepared using a Twin screw extruder (Toshiba TEM-37BS, L/D=40.5) and the temperature of the extruder barrel was set at about 250 to about 300° C.

The moldable composition comprising the foregoing mentioned organic polymer and the fillers may be subject to multiple blending and forming steps if desirable. For example, the moldable composition may first be extruded and formed into pellets. The pellets may then be fed into a molding machine where it may be formed into any desirable shape or product. Alternatively, the moldable composition emanating from a single melt blender may be formed into sheets or strands and subjected to post-extrusion processes such as annealing, uniaxial or biaxial orientation.

### Sample Coating Process

Pellets extruded from extruder were then injection molded into a 80 mm×10 mm×3 mm bar and cut into 10 mm×10 mm×3 mm sample for coating. The coating process may require several steps, including, for example, sample surface preparation, mixing the coating, spray coating on the part surface, curing, and clean up. As an example, the coating may comprise polyurethane as resin and may also comprise fillers (as described herein). In addition, the coating may comprise Al2O3, Ag in line shape, and/or MgO in sphere shape. Other coatings having the similar or different compositions may be used.

### Aspects

The present disclosure comprises at least the following aspects.

Aspect 1. An article comprising: a substrate formed from a thermoplastic or thermoset; and a thermal conductive or heat absorptive coating disposed adjacent the substrate to form a composite stack, wherein the composite stack is characterized by through plane thermal conductivity higher than about 8 W/m*K.

Aspect 2. An article comprising: a substrate formed from a thermoplastic or thermoset; and a thermal conductive or heat absorptive coating disposed adjacent the substrate to form a composite stack, wherein the composite stack is characterized by through plane thermal conductivity between about 6 W/m*K and about 12 W/m*K.

Aspect 3. An article comprising: a substrate formed from a thermoplastic or thermoset; and a thermal conductive or heat absorptive coating disposed adjacent the substrate to form a composite stack, wherein the composite stack is characterized by an increase of through plane thermal conductivity of at least 2 W/m*K, when compared to the substrate without the coating.

Aspect 4. The article of any one of aspects 1-3, wherein the thermoplastic polymer comprises a polypropylene, polyethylene, ethylene based copolymer, polycarbonate, polyamide, polyester, polybutylene terephthalate (PBT), polyethylene terephthalate (PET), polycyclohexylendimethylene terephthalate (PCT), liquid crystal polymers (LPC), polyphenylene Sulfide (PPS), polyphenylene ether (PPE), polyphenylene oxide-polystyrene blends, polystyrene, high impact modified polystyrene, acrylonitrile-butadiene-styrene (ABS) terpolymer, acrylic polymer, polyetherimide (PEI), polyurethane, polyetheretherketone (PEEK), poly ether sulphone (PES), and mixtures of any of the foregoing.

Aspect 5. The article of any one of aspects 1-4, wherein the thermoplastic or thermoset is a pure resin.

Aspect 6. The article of any one of aspects 1-4, wherein the thermoplastic or thermoset comprises one or more of a filler, impact modifier, FR component, reinforce agent, stabilizer, or additive, or a combination thereof.

Aspect 7. The article of any one of aspects 1-6, wherein the article is flexible.

Aspect 8. The article of any one of aspects 1-7, wherein the coating is configured to provide a supplemental benefit including high reflectivity (e.g., greater than 80%), electrical conductive (e.g., surface resistance less than E+5 Ohm/Sq), electrical isolative (e.g., dielectric strength (DS) greater than 4 kV/mm), EMI shielding (e.g., greater than 20 dB with frequency band at about 3 GHz), laser marking (e.g., visible, intensity variation at least 40 is observed between a laser-marked region and a non-marked region of the composition), or combination of thereof.

Aspect 9. The article of any one of aspects 1-8, wherein the coating is capable of having any color.

Aspect 10. The article of any one of aspects 1-9, wherein the coating is in the form of liquid, solid, gas phase, or combination of thereof.

Aspect 11. The article of any one of aspects 1-10, wherein the coating is applied using a conventional coating technique.

Aspect 12. The article of any one of aspects 1-11, wherein the coating is applied using a spray gun, in molding coating process, flame painting, or a combination thereof.

Aspect 13. The article of any one of aspects 1-11, wherein the coating comprises a plurality of coating layers.

Aspect 14. The article of aspect 13, wherein at least one of the plurality of coating layers is a thermal conductive or thermal absorptive coating layer.

Aspect 15. The article of aspect 13, wherein the thickness of each of the plurality of coating layers is between about 20 nm and about 2 mm.

Aspect 16. The article any one of aspects 1-14, wherein the thickness of the coating is between about 20 nm and about 2 mm.

Aspect 17. The article of any one of aspects 1-16, wherein the coating is applied to about 2% to about 100% of the area of the substrate.

Aspect 18. An article comprising: a substrate formed from a thermoplastic or thermoset; and a thermal conductive or heat absorptive coating disposed adjacent the substrate to form a composite stack, wherein the composite stack is characterized by an increase of through plane thermal conductivity of at least 2 W/m*K, when compared to a comparative stack consisting essentially of the substrate.

Aspect 19. The article of aspect 18, wherein the thermoplastic polymer comprises a polypropylene, polyethylene, ethylene based copolymer, polycarbonate, polyamide, polyester, polybutylene terephthalate (PBT), polyethylene terephthalate (PET), polycyclohexylendimethylene terephthalate (PCT), liquid crystal polymers (LPC), polyphenylene Sulfide (PPS), polyphenylene ether (PPE), polyphenylene oxide-polystyrene blends, polystyrene, high impact modified polystyrene, acrylonitrile-butadiene-styrene (ABS) terpolymer, acrylic polymer, polyetherimide (PEI), polyurethane, polyetheretherketone (PEEK), poly ether sulphone (PES), and mixtures of any of the foregoing.

Aspect 20. The article of any one of aspects 18-19, wherein the thermoplastic or thermoset is a pure resin.

Aspect 21. The article of any one of aspects 18-20, wherein the thermoplastic or thermoset comprises one or more of a filler, impact modifier, FR component, reinforce agent, stabilizer, or additive, or a combination thereof.

Aspect 22. The article of any one of aspects 18-21, wherein the article is flexible.

Aspect 23. The article of any one of aspects 18-22, wherein the coating is configured to provide a supplemental benefit including high reflectivity (e.g., greater than 80%), electrical conductive (e.g., surface resistance less than E+5 Ohm/Sq), electrical isolative (e.g., dielectric strength (DS) greater than 4 kV/mm), EMI shielding (e.g., greater than 20 dB with frequency band at about 3 GHz), laser marking (e.g., visible, intensity variation at least 40 is observed between a laser-marked region and a non-marked region of the composition), or combination of thereof.

Aspect 24. The article of any one of aspects 18-23, wherein the coating is capable of having any color.

Aspect 25. The article of any one of aspects 18-24, wherein the coating is in the form of liquid, solid, gas phase, or combination of thereof.

Aspect 26. The article of any one of aspects 18-25, wherein the coating is applied using a conventional coating technique.

Aspect 27. The article of any one of aspects 18-26, wherein the coating is applied using a spray gun, in molding coating process, flame painting, or a combination thereof.

Aspect 28. The article of any one of aspects 18-27, wherein the coating comprises a plurality of coating layers.

Aspect 29. The article of aspect 28, wherein at least one of the plurality of coating layers is a thermal conductive or thermal absorptive coating layer.

Aspect 30. The article of any one of aspects 28-29, wherein the thickness of each of the plurality of coating layers is between about 20 nm and about 2 mm.

Aspect 31. The article any one of aspects 18-30, wherein the thickness of the coating is between about 20 nm and about 2 mm.

Aspect 32. The article of any one of aspects 18-31, wherein the coating is applied to about 2% to about 100% of the area of the substrate.

### Evaluation: Thermal Conductivity

The samples having dimension of 10 mm×10 mm×3 mm, with and without coating, were used for thermal conductivity (TC) testing. Thermal conductivity, (W/m-K), is measured by Nanoflash LFA447 using a pyroceram reference with similar thickness. The measurement determines the thermal diffusivity (mm2/s) and the specific heat (Cp, J/g-K) of the sample, together with the density (g/cm3), which is measured using a water immersion method (ASTM D792). The product of three value provides the thermal conductivity in the through plane direction and in plane direction according to: K=α(T)Cp(T)ρ(T). In the following examples, each point was repeated three times to make sure the accurate TC was measured.

### Results:

Table 2 illustrates an example formula composite and thermal conductivity results. The example formula of thermal conductive composition in Table 2 includes graphite as thermal conductive filler, magnesium hydroxide performs as both thermal conductive filler and FR component. The plastic composition can achieve a thermal conductivity about 5.7 w/m*K at through plane direction and 16 w/m*K at in plane direction.

(2) TABLE 2. EXAMPLE FORMULA THERMOPLASTIC
COMPOSITES AND THE THERMAL CONDUCTIVITY

| | | Control sample |
|---|---|---|
| 83900 | PA6 Regular - NV HAEG | 29.65 |
| F325125 | TEGOMER ANTISCRATCH 200 | 2 |
| F494471 | Magnesium Hydroxide H5-IV | 33 |
| F544397 | Asbury graphite 1125 | 20 |
| F54GR50 | SGL graphite GFG50 | 15 |
| F542 | PHOSPHITE STABILIZER | 0.15 |
| 25808 | Phenolic prim antioxidant for PA | 0.2 |

| | | |
|---|---|---|
| Through plane Thermal | W/m * K | 5.7 |
| conductivity | | |
| In plane Thermal conductivity | W/m * K | 16 |

For through plane thermal conductivity testing by LFA447 instrument, sample should be rectangular block with dimension of 10 mm×10 mm×3 mm and the largest surface having dimension of 10 mm×10 mm will receive the laser. An IR detector is disposed opposite the incident side of the sample to measure through plane conductivity. For pure plastic sample, there should be no difference if shadowed surface to receive the laser or its opposite surface.

Table 3 illustrates the thermal conductivity of the thermal plastic composition of Table 2 with Z306 coating.

TABLE 3
(3) THERMAL CONDUCTIVITY OF
PLASTIC COMPOSITION WITH Z306 COATING

| Test Code | | Control | 1 | 2 | 3 | 4 | 5 | 6 |
|---|---|---|---|---|---|---|---|---|
| Coating | | — | Single side | | | | both sides | |
| type | | | | | | | | |
| Coating | um | 0 | 12 | | 55 | | 27 | 205 |
| thickness | | | | | | | | |
| which | | | painting | plastic | painting | plastic | painting | painting |
| surface to | | | | | | | | |
| receive laser | | | | | | | | |
| Thermal | mm²/ | | 1.989 | 2.004 | 3.264 | 3.312 | 1.944 | 1.943 |
| Diffusivity | s | | | | | | | |
| Thermal | W/m* | 5.7 | 5.302 | 5.409 | 8.182 | 8.027 | 5.401 | 5.317 |
| Conductivity | K | | | | | | | |
| Heat | J/g/K | | 1.559 | 1.579 | 1.466 | 1.417 | 1.625 | 1.6 |
| capacity | | | | | | | | |

As shown in Table 3, two types of coated samples were prepared. One type includes spray coating on the shadowed surface of thermal plastic composition (referred to as single side coating). The second type of coated sample includes coating the shadowed surface and the opposite surface (or the whole part was coated), which is referred to as both sides coating in Table 3. For each type of coating, two thickness were applied and tested.

As illustrated in Table 3, where a single side is coated and a thicker coating layer is used, improvement is achieved in thermal conductivity (e.g., from 5.7 W/m*K to more than 8 W/m*K). Such an increase from an uncoated sample is about a 43.5% increase and is independent of the coating surface or plastic surface to receive laser during thermal conductivity testing. Such improvement in thermal conductivity is due at least in part to an increase in thermal diffusivity by including the coating.

Another coating using E1007580 PT A/E1007680 PT B mixture is applied and the thermal conductivity is listed in Table 4, below.

TABLE 4
(4) THERMAL CONDUCTIVITY OF PLASTIC COMPOSITION
WITH E1007580 PT A/E1007680 PT B COATING

| | | Control | 7 | 8 | 9 | 10 | 11 | 12 |
|---|---|---|---|---|---|---|---|---|
| Coating type | | — | Single side | | | | both sides | |
| Coating | um | 0 | 50 | | 35 | | 27 | 41 |
| thickness | | | | | | | | |
| which surface | | plastic | painting | plastic | painting | plastic | painting | painting |
| to receive | | | | | | | | |
| laser | | | | | | | | |
| Thermal | mm²/s | | 2.371 | 2.478 | 2.163 | 2.1 | 3.864 | 2.346 |
| Diffusivity | | | | | | | | |
| Thermal | W/m*K | 5.7 | 5.976 | 6.367 | 5.707 | 5.42 | 9.274 | 6.207 |
| Conductivity | | | | | | | | |
| Heat capacity | J/g/K | | 1.474 | 1.502 | 1.543 | 1.509 | 1.404 | 1.547 |

As illustrated in Table 4, when the whole plastic was coated and a thinner coating layer is used, the thermal conductivity can achieve about 9.2 W/m*K, increasing by 42.7% over the uncoated sample. As an example, coating with thermal conductivity or heat absorptive functional coating can help thermal plastics to achieve super high thermal conductivity.

### Definitions

It is to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural equivalents unless the context clearly dictates otherwise. Thus, for example, reference to “a polycarbonate polymer” includes mixtures of two or more polycarbonate polymers.

As used herein, the term “combination” is inclusive of blends, mixtures, alloys, reaction products, and the like.

Ranges can be expressed herein as from one particular value to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±5% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

Unless otherwise stated to the contrary herein, all test standards are the most recent standard in effect at the time of filing this application.

What is claimed is:

1. An article comprising:
a. a substrate formed from a thermoplastic or thermoset; and
b. a thermal conductive or heat absorptive coating disposed adjacent the substrate to form a composite stack,
wherein the composite stack is characterized by a through plane thermal conductivity that is:
higher than about 8 W/m*K,
between about 6 W/m*K and about 12 W/m*K, or
at least about 2 W/m*K higher than that of a substrate that does not include the coating.

2. (canceled)

3. (canceled)

4. The article of claim 1, wherein the thermoplastic polymer comprises a polypropylene, polyethylene, ethylene based copolymer, polycarbonate, polyamide, polyester, polybutylene terephthalate (PBT), polyethylene terephthalate (PET), polycyclohexylendimethylene terephthalate (PCT), liquid crystal polymers (LPC), polyphenylene Sulfide (PPS), polyphenylene ether (PPE), polyphenylene oxide-polystyrene blends, polystyrene, high impact modified polystyrene, acrylonitrile-butadiene-styrene (ABS) terpolymer, acrylic polymer, polyetherimide (PEI), polyurethane, polyetheretherketone (PEEK), poly ether sulphone (PES), and mixtures of any of the foregoing.

5. The article of claim 1, wherein the thermoplastic or thermoset is a pure resin.

6. The article of claim 1, wherein the thermoplastic or thermoset comprises one or more of a filler, impact modifier, FR component, reinforce agent, stabilizer, or additive, or a combination thereof.

7. The article of claim 1, wherein the article is flexible.

8. The article of claim 1, wherein the coating is configured to provide a supplemental benefit including high reflectivity, electrical conductive, electrical isolative, EMI shielding, laser marking or combination of thereof.

9. The article of claim 1, wherein the coating is capable of having any color.

10. The article of claim 1, wherein the coating is in the form of liquid, solid, gas phase, or combination of thereof.

11. The article of claim 1, wherein the coating is applied using a conventional coating technique.

12. The article of claim 1, wherein the coating is applied using a spray gun, in molding coating process, flame painting, or a combination thereof.

13. The article of claim 1, wherein the coating comprises a plurality of coating layers.

14. The article of claim 13, wherein at least one of the plurality of coating layers is a thermal conductive or thermal absorptive coating layer.

15. The article of claim 13, wherein the thickness of each of the plurality of coating layers is between about 20 nm and about 2 mm.

16. The article of claim 1, wherein the thickness of the coating is between about 20 nm and about 2 mm.

17. The article of claim 1, wherein the coating is applied to about 2% to about 100% of the area of the substrate.
